(19) United States
(12) Patent Application Publication
(10) Pub. No.: US 2023/0324686 A1
(43) Pub. Date: Oct. 12, 2023

(54) ADAPTIVE CONTROL OF OPTICAL TRANSMISSION

(71) Applicant: Meta Platforms Technologies, LLC, Menlo Park, CA (US)

(72) Inventors: Robin Sharma, Redmond, WA (US); Michael Scott Fenton, Sunnyvale, CA (US); Afsoon Jamali, Redmond, WA (US)

(21) Appl. No.: 17/717,706

(22) Filed: Apr. 11, 2022

(51) Int. Cl. G02B 27/01; G06F 3/01

(52) U.S. Cl. CPC G02B 27/0172; G02B 27/0179; G06F 3/013; G02B 2027/0178; G02B 2027/014; G02B 2027/011; G02B 2027/0187

(57) ABSTRACT

A head mounted device includes a light sensor configured to generate light data in response to measuring scene light in an external environment of the head mounted device, a display configured to present a virtual image to an eyebox area of the head mounted device, a near-eye dimming element configured to modulate a transmission of the scene light to the eyebox area in response to a transmission command, and processing logic configured to adjust the transmission command of the dimming element in response to a brightness level of the virtual image and the light data generated by the light sensor.

### TECHNICAL FIELD

This disclosure relates generally to optics, and in particular to a head mounted device.

### BACKGROUND INFORMATION

A head mounted device is a wearable electronic device, typically worn on the head of a user. Head mounted devices may include one or more electronic components for use in a variety of applications, such as gaming, aviation, engineering, medicine, entertainment, activity tracking, and so on. Head mounted devices may include display to present virtual images to a wearer of the head mounted device. When a head mounted device includes a display, it may be referred to as a head mounted display. Head mounted devices may have user inputs so that a user can control one or more operations of the head mounted device.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example head mounted device, in accordance with aspects of the disclosure.

FIGS. 2A and 2B show examples of a field of view for the head mounted device of FIG. 1, in accordance with aspects of the disclosure.

FIGS. 3A and 3B show further examples of a field of view for the head mounted device of FIG. 1, in accordance with aspects of the disclosure.

FIG. 4 illustrates a top view of a portion of an example head mounted device, in accordance with aspects of the disclosure.

FIG. 5 is a flow diagram illustrating adaptive control of optical transmission, in accordance with aspects of the disclosure.

FIG. 6 is a flow diagram illustrating adaptive control of optical transmission, in accordance with aspects of the disclosure.

FIG. 7 is a flow diagram illustrating adaptive control of optical transmission, in accordance with aspects of the disclosure.

FIG. 8 is a flow diagram illustrating adaptive control of optical transmission, in accordance with aspects of the disclosure.

FIG. 9 is a flow diagram illustrating adaptive control of optical transmission, in accordance with aspects of the disclosure.

FIG. 10 is a flow diagram illustrating adaptive control of optical transmission, in accordance with aspects of the disclosure.

FIG. 11 illustrates a flow chart of an example method to improve contrast for a virtual image provided by a head mounted device, in accordance with aspects of the disclosure.

### DETAILED DESCRIPTION

Embodiments of adaptive control of optical transmission in augmented reality (AR) devices are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A head mounted device (and related method) for adaptive control of optical transmission, as provided in this disclosure, addresses a situation, such as in an augmented reality (AR) implementation, a virtual image overlays/superimposes over a scene of an environment external to the head mounted device. Due to a brightness level of scene light (e.g., ambient light) in the scene, it may be difficult for a user of the head mounted device to see the details of the virtual image in the field of view (FOV) of the head mounted device, for example, if a high brightness level of the scene light reduces a contrast of the virtual image with respect to the scene. Accordingly, the head mounted device is provided with capability and features to provide dimming of the scene light that propagates through the head mounted device, so that the scene light propagating through the head mounted device can be dimmed when needed and in an adaptive and dynamic manner, thereby improve the contrast and other visibility of the virtual image.

Determining whether dimming is appropriate may be based on a plurality of inputs to processing logic provided by a corresponding plurality of sensors. These sensors may include an ambient light sensor, a display brightness sensor, a stack transmission sensor, a temperature sensor, an eye-tracking camera, and so forth. For instance, a head mounted device may include a light sensor configured to generate light data in response to measuring scene light in an external environment of the head mounted device, a display configured to present a virtual image to an eyebox area of the head mounted device, a near-eye dimming element configured to modulate a transmission of the scene light to the eyebox area in response to a transmission command, and processing logic configured to adjust the transmission command of the dimming element in response to a brightness level of the virtual image and the light data generated by the light sensor.

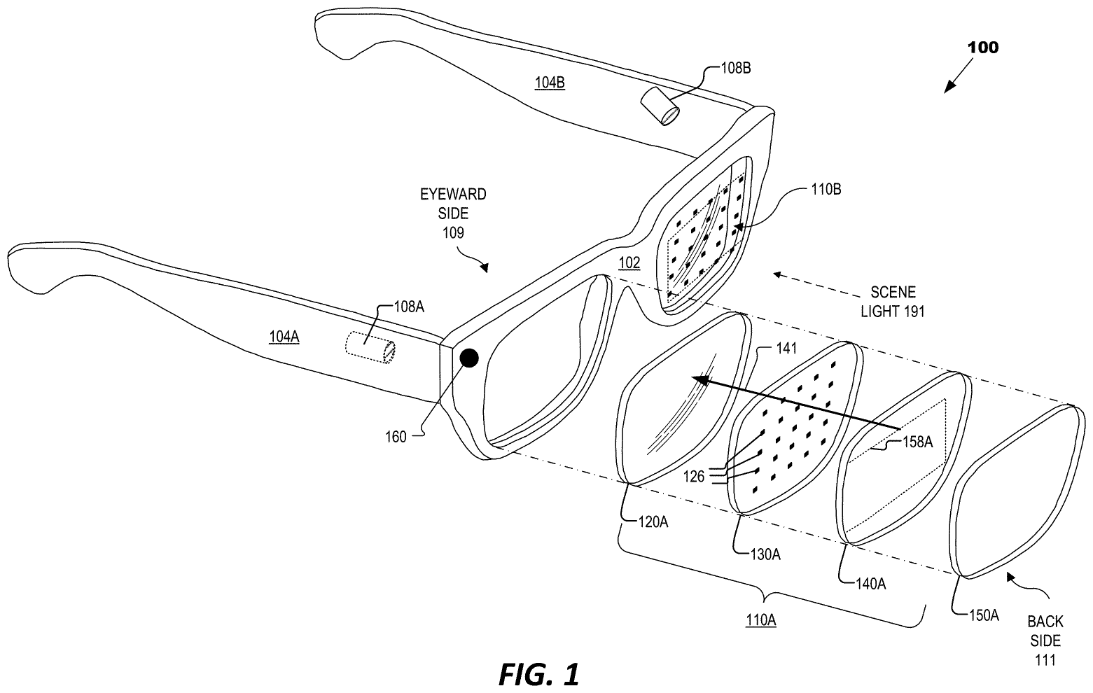

By using the information/data from these sensors in combination, the processing logic for the head mounted device is able to more accurately monitor brightness in the scene and in the display, determine whether some adjustment to the dimming element and/or to the display is needed in order to achieve an appropriate contrast result, perform the adjustments, etc., with the monitoring, determinations, and adjustments being performed in an automatic and more efficient manner as the user moves within or between scenes, views different/multiple virtual images, experiences scene changes, etc. These and other embodiments are described in more detail in connection with FIGS. 1-11.

FIG. 1 illustrates an example head mounted device 100, in accordance with aspects of the present disclosure. The illustrated example of head mounted device 100 is shown as including a frame 102, temple arms 104A and 104B, and near-eye optical elements 110A and 110B. Cameras 108A and 108B are shown as coupled to temple arms 104A and 104B, respectively. Cameras 108A and 108B may be configured to image an eyebox region to image the eye of the user to capture eye data of the user. For example and as will be described later below, cameras 108A and 108B may be used for eye-tracking and related processing to determine the size and/or position of various features of the user's eyes, such as pupil size.

Cameras 108A and 108B may image the eyebox region directly or indirectly. For example, optical elements 110A and/or 110B may have an optical combiner that is configured to redirect light from the eyebox to the cameras 108A and/or 108B. In some implementations, near-infrared light sources (e.g. LEDs or vertical-cavity side emitting lasers) illuminate the eyebox region with near-infrared illumination light, and cameras 108A and/or 108B are configured to capture infrared images. Cameras 108A and/or 108B may include complementary metal-oxide semiconductor (CMOS) image sensor. A near-infrared filter that receives a narrow-band near-infrared wavelength may be placed over the image sensor so that the image sensor is sensitive to the narrow-band near-infrared wavelength while rejecting visible light and wavelengths outside the narrow-band. The near-infrared light sources may emit the narrow-band wavelength that is passed by the near-infrared filters.

Sensor 160 is positioned on frame 102, and/or positioned on or otherwise proximate to either or both optical elements 110A and 110B or elsewhere in head mounted device 100. Sensor(s) 160 may include one or more of an ambient light sensor (including a RGB camera, monochromatic camera, photodiode etc.) or a temperature sensor. As will be described later below, the data provided by sensor(s) 160 may be used by processing logic to control dimming or to otherwise control characteristics (such as brightness, contrast, etc.) of head mounted device 100 with respect to a scene and virtual image that is presented in a field of view of head mounted device 100.

While FIG. 1 only shows a single sensor 160 that is positioned on the front face of frame 102 near the temple arm 104A, it is understood that the depiction in FIG. 1 is merely an example. Singular or multiple sensors 160 may located at frame 102 near the other temple arm 104B, at other locations on frame 102, at either or both temple arms 104A and 104B, near or within either or both optical elements 110A and 110B, or elsewhere (including on a separate attachment or other structure/assembly that may be coupled to head mounted device 100.

FIG. 1 also illustrates an exploded view of an example of near-eye optical element 110A. Near-eye optical element 110A is shown as including an optically transparent layer 120A, an illumination layer 130A, a display layer 140A, and a transparency modulator layer 150A. Display layer 140A may include a waveguide 158A that is configured to direct virtual images included in visible image light 141 to an eye of a user of head mounted device 100 that is in an eyebox region of head mounted device 100. In some implementations, at least a portion of the electronic display of display layer 140A is included in frame 102 of head mounted device 100. The electronic display may include an LCD, an organic light emitting diode (OLED) display, micro-LED display, pico-projector, or liquid crystal on silicon (LCOS) display for generating the image light 141.

When head mounted device 100 includes a display, it may be considered to be a head mounted display. Head mounted device 100 may be considered to be an augmented reality (AR) head mounted display. While FIG. 1 illustrates a head mounted device 100 configured for augmented reality (AR) or mixed reality (MR) contexts, the disclosed embodiments may also be used in other implementations of a head mounted display such as virtual reality head mounted displays.

Illumination layer 130A is shown as including a plurality of in-field illuminators 126. In-field illuminators 126 are described as “in-field” because they are in a field of view (FOV) of a user of the head mounted device 100. In-field illuminators 126 may be in a same FOV that a user views a display of the head mounted device 100, in an embodiment. In-field illuminators 126 may be in a same FOV that a user views an external environment of the head mounted device 100 via scene light 191 propagating through near-eye optical elements 110. Scene light 191 is from the external environment of head mounted device 100. While in-field illuminators 126 may introduce minor occlusions into the near-eye optical element 110A, the in-field illuminators 126, as well as their corresponding electrical routing may be so small as to be unnoticeable or insignificant to a wearer of head mounted device 100. In some implementations, illuminators 126 are not in-field. Rather, illuminators 126 could be out-of-field in some implementations.

As shown in FIG. 1, frame 102 is coupled to temple arms 104A and 104B for securing the head mounted device 100 to the head of a user. Example head mounted device 100 may also include supporting hardware incorporated into the frame 102 and/or temple arms 104A and 104B. The hardware of head mounted device 100 may include any of processing logic, wired and/or wireless data interface for sending and receiving data, graphic processors, and one or more memories for storing data and computer-executable instructions. In one example, head mounted device 100 may be configured to receive wired power and/or may be configured to be powered by one or more batteries. In addition, head mounted device 100 may be configured to receive wired and/or wireless data including video data.

FIG. 1 illustrates near-eye optical elements 110A and 110B that are configured to be mounted to the frame 102. In some examples, near-eye optical elements 110A and 110B may appear transparent or semi-transparent to the user to facilitate augmented reality or mixed reality such that the user can view visible scene light from the environment while also receiving image light 141 directed to their eye(s) by way of display layer 140A.

As shown in FIG. 1, illumination layer 130A includes a plurality of in-field illuminators 126. Each in-field illuminator 126 may be disposed on a transparent substrate and may be configured to emit light to an eyebox region on an eyeward side 109 of the near-eye optical element 110A. In some aspects of the disclosure, the in-field illuminators 126 are configured to emit near infrared light (e.g. 750 nm-1.6 μm). Each in-field illuminator 126 may be a micro light emitting diode (micro-LED), an edge emitting LED, a vertical cavity surface emitting laser (VCSEL) diode, or a superluminescent diode (SLED).

Optically transparent layer 120A is shown as being disposed between the illumination layer 130A and the eyeward side 109 of the near-eye optical element 110A. The optically transparent layer 120A may receive the infrared illumination light emitted by the illumination layer 130A and pass the infrared illumination light to illuminate the eye of the user. As mentioned above, the optically transparent layer 120A may also be transparent to visible light, such as scene light 191 received from the environment and/or image light 141 received from the display layer 140A. In some examples, the optically transparent layer 120A has a curvature for focusing light (e.g., display light and/or scene light) to the eye of the user. Thus, the optically transparent layer 120A may, in some examples, may be referred to as a lens. In some aspects, the optically transparent layer 120A has a thickness and/or curvature that corresponds to the specifications of a user. In other words, the optically transparent layer 120A may be a prescription lens. However, in other examples, the optically transparent layer 120A may be a non-prescription lens.

Transparency modulator layer 150A may be superimposed over display layer 140A at a backside 111, such that transparency modulator layer 150A is facing a scene that is being viewed by the user in the FOV of head mounted device 100. According to various embodiments, transparency modulator layer 150A may include a dimming element that is configured to control an amount (e.g., intensity) of scene light 191 that is transmitted through optical element 110A. The dimming element may be controlled to reduce or increase an intensity of scene light 191, so as to provide an appropriate contrast between a scene and a virtual image that are presented in a FOV of head mounted device 100.

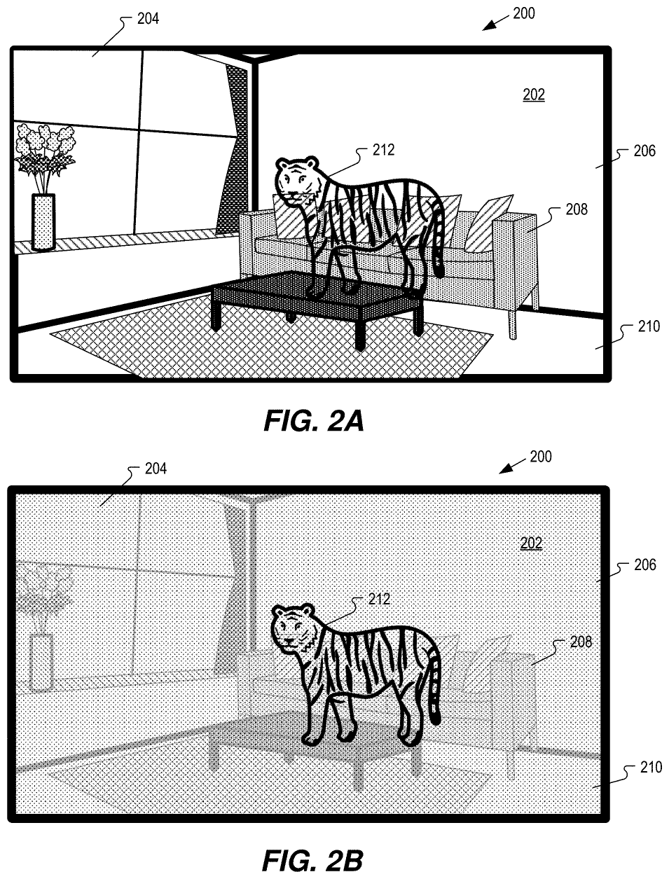

For example, FIG. 2A shows an example FOV 200 of head mounted device 100. The user of head mounted device 100 is viewing a scene 202 in FOV 200, which in this example is a living room having an area 204 (e.g., having a window), an area 206 (e.g., having a wall), an area 208 (e.g., having furniture), and an area 210 (e.g., having a floor). Ambient light in the living room illuminates scene 202 and is transmitted as scene light 191 through transparency modulator layer 150A. It is also noted that area 204 may be brighter than areas 206-210 due to sunlight passing through the window. Other example areas that may be brighter relative to other areas in scene 202 may have lamps, computer screens or other active display screens, overhead lighting, surfaces with light incident thereon, etc.

FIG. 2A also shows that a virtual image 212 (e.g., a tiger) is presented in FOV 200. Virtual image 212 in the example of FIG. 2A is positioned in scene 202 such that at least some portion of virtual image 212 is superimposed over (e.g., overlays) the wall in area 206, the furniture in area 208, and the floor in area 210. Due to the amount of ambient light in scene 202, virtual image 212 may be difficult to see or may be presented with details that are unclear to the user. For example, if the dimming element in transparency modulator layer 150A of head mounted device 100 provides relatively minimal or no dimming of scene light 191, then it may be difficult for the user to view the contrast between virtual image 212 and scene 202.

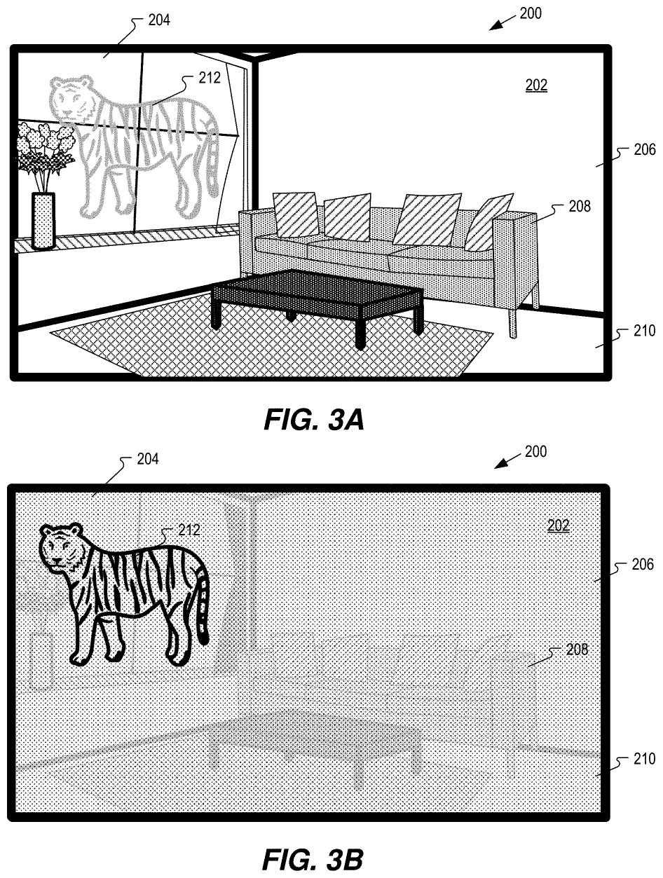

Therefore, FIG. 2B shows an example wherein the dimming element provides a dimming of scene light 191, with such dimming being symbolically represented in FIG. 2B (as well as in FIG. 3B) by gray shading in scene 202. Specifically, the dimming element may reduce the intensity of scene light 191 that is transmitted through transparency modulator layer 150A to display layer 140A and to the subsequent layers in optical element 110A. For instance in FIG. 2B, the intensity of scene light 191 that is permitted by the dimming element to be propagated to display layer 140A and to the other layers may be 20% of the (undimmed) intensity of scene light 191 (e.g., an 80% reduction in the ambient light, or a 20% transparency or transmission rate). With such a reduction in the intensity of transmitted scene light 191, virtual image 212 in FIG. 2B becomes more visible in FOV 200 against the dimmed lighting in scene 202. In some embodiments, the dimming provided in FIG. 2B may be a global dimming in that the entire FOV 200 such that scene 202 is dimmed by the same amount in all of its areas.

FIGS. 3A and 3B depict examples wherein virtual image 212 is superimposed over the relatively brighter area 204 having the window. In FIG. 3A wherein there is relatively minimal or no dimming of scene light 191, the high amount of brightness in area 204 makes it more difficult to see virtual image 212 (symbolically depicted in a faded manner with gray lines) in area 204 as compared to other areas 206-210 of scene 202, for example since there is insufficient contrast between virtual image 212 and the contents of area 204.

FIG. 3B shows an example of global dimming for the scene 202 in which there is a greater amount of dimming than in FIG. 2B. The dimming in FIG. 3B may involve a 10% transparency of scene light 191, as compared to a 20% transparency of scene light 191 in FIG. 2B. This greater amount of dimming in FIG. 3B enables virtual image 212, which is positioned over the area 204, to have more contrast and thus more readily visible to the user.

According to various embodiments that will be described later below, a region of interest (ROI) may be defined for virtual image 212, such that the amount of dimming may be performed dependent upon whether the ROI is positioned over a relatively brighter area of scene 202. The ROI can have, for example, a size and shape that generally corresponds to the external outline of virtual image 212 (e.g., a ROI in the shape of a tiger). As another example, the ROI can have a more general shape, such as a rectangle, box, ellipse, polygon, etc. that encompasses the external outline of virtual image 212.

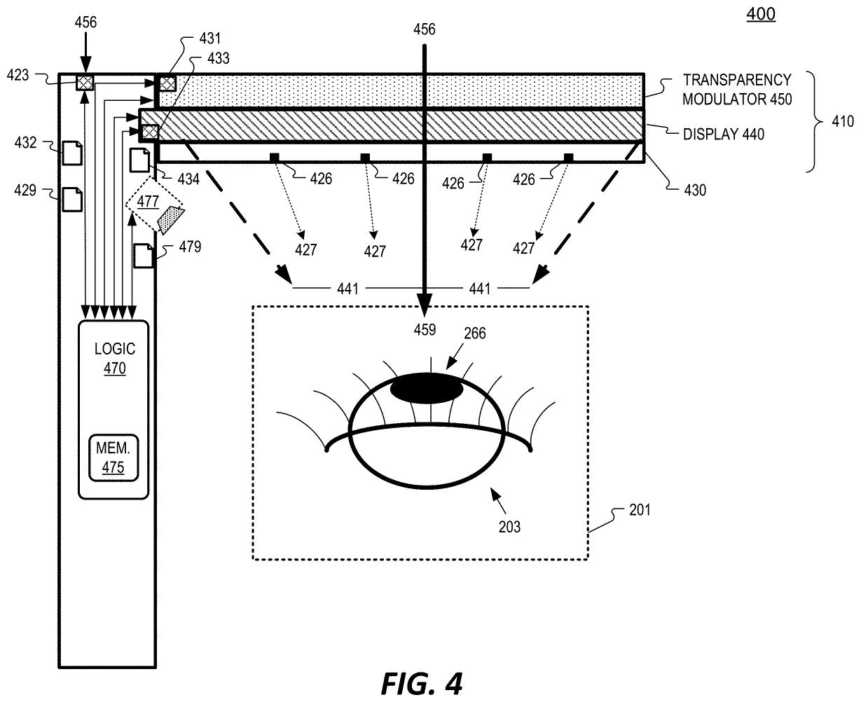

FIG. 4 illustrates a top view of a portion of an example head mounted device 400, in accordance with implementations of the disclosure. Head mounted device 400 may provide the dimming capability described above with respect to FIGS. 2A and 2B and FIGS. 3A and 3B. Head mounted device 400 may have some similar features as head mounted device 100 of FIG. 1, with further details now being provided for at least some of the same or similar elements as head mounted device 100.

Head mounted device 400 may include an optical element 410 that includes a transparency modulator layer 450, a display layer 440, and an illumination layer 430. Additional optical layers (not specifically illustrated) may also be included in example optical element 410. For example, a focusing lens layer may optionally be included in optical element 410 to focus scene light 456 and/or virtual images included in image light 441 generated by display layer 440. Transparency modulator layer 450 (which includes a dimming element) modulates the intensity of incoming scene light 456 so that the scene light 459 that propagates to eyebox region 201 may have a reduced intensity when compared to the intensity of incoming scene light 456.

Display layer 440 presents virtual images in image light 441 to an eyebox region 201 for viewing by an eye 203. Processing logic 470 is configured to drive virtual images onto display layer 440 to present image light 441 to eyebox region 201. Processing logic 470 is also configured to adjust a brightness of display layer 440. In some implementations, adjusting a display brightness of display layer 440 includes adjusting the intensity of one or more light sources of display layer 440. All or a portion of display layer 440 may be transparent or semi-transparent to allow scene light 456 from an external environment to become incident on eye 203 so that a user can view their external environment in addition to viewing virtual images presented in image light 441, such as described above with respect to FIGS. 2A and 2B and FIGS. 3A and 3B.

Transparency modulator layer 450 may be configured to change its transparency to modulate the intensity of scene light 456 that propagates to the eye 203 of a user. Processing logic 470 may be configured to drive an analog or digital signal onto transparency modulator layer 450 in order to modulate the transparency of transparency modulator layer 450. In an example implementation, transparency modulator layer 450 includes a dimming element comprised of liquid crystals wherein the alignment of the liquid crystals is adjusted in response to a drive signal from processing logic 470 to modulate the transparency of transparency modulator layer 450. Other suitable technologies that allow for electronically and/or optically controlled dimming of the dimming element may be included in transparency modulator layer 450. Example technologies may include, but are not limited to, electrically activated guest host liquid crystal technology in which a guest host liquid crystal coating is present on a lens surface, photochromic dye technology in which photochromic dye embedded within a lens is activated by ultraviolet (UV) or blue light, or other dimming technologies that enable controlled dimming through electrical, optical, mechanical, and/or other activation techniques.

Illumination layer 430 includes light sources 426 configured to illuminate an eyebox region 201 with infrared illumination light 427. Illumination layer 430 may include a transparent refractive material that functions as a substrate for light sources 426. Infrared illumination light 427 may be near-infrared illumination light. Camera 477 is configured to image (directly) eye 203, in the illustrated example of FIG. 4. In other implementations, camera 447 may (indirectly) image eye 203 by receiving reflected infrared illumination light from an optical combiner layer (not illustrated) included in optical element 410. The optical combiner layer may be configured to receive reflected infrared illumination light (the infrared illumination light 427 reflected from eyebox region 201) and redirect the reflected infrared illumination light to camera 447. In this implementation, camera 447 would be oriented to receive the reflected infrared illumination light from the optical combiner layer of optical element 410.

Camera 447 may include a complementary metal-oxide semiconductor (CMOS) image sensor, in some implementations. An infrared filter that receives a narrow-band infrared wavelength may be placed over the image sensor so that it is sensitive to the narrow-band infrared wavelength while rejecting visible light and wavelengths outside the narrow-band. Infrared light sources (e.g. light sources 426) such as infrared LEDs or infrared VCSELS that emit the narrow-band wavelength may be oriented to illuminate eye 203 with the narrow-band infrared wavelength. Camera 447 may capture eye-tracking images of eyebox region 201. Eyebox region 201 may include eye 203 as well as surrounding features in an ocular area such as eyebrows, eyelids, eye lines, etc. Processing logic 470 may initiate one or more image captures with camera 477 and camera 477 may provide eye-tracking images 479 to processing logic 470. Processing logic 470 may perform image processing to determine the size and/or position of various features of the eyebox region 201. For example, processing logic 470 may perform image processing to determine a pupil position or pupil size of pupil 266. Light sources 426 and camera 477 are merely an example eye-tracking configuration and other suitable eye-tracking systems and techniques may also be used to capture eye data, in implementations of the disclosure.

In the illustrated implementation of FIG. 4, a memory 475 is included in processing logic 470. In other implementations, memory 475 may be external to processing logic 470. In some implementations, memory 475 is located remotely from processing logic 470. In implementations, virtual image(s) are provided to processing logic 470 for presentation in image light 441. In some implementations, virtual images are stored in memory 475. Processing logic 470 may be configured to receive virtual images from a local memory or the virtual images may be wirelessly transmitted to the head mounted device 400 and received by a wireless interface (not illustrated) of the head mounted device.

FIG. 4 illustrates that processing logic 470 is communicatively coupled to ambient light sensor 423. Processing logic 470 may be communicatively coupled to a plurality of ambient light sensors, in some implementations. Ambient light sensor 423 may include one or more photodetectors (e.g., photodiodes). Ambient light sensor 423 may include more than one photodetector with corresponding filters so that ambient light sensor 423 can measure the color as well as the intensity of scene light 456. Ambient light sensor 423 may include a red-green-blue (RGB)/infrared/monochrome camera sensor to generate high certainty measurements about the state of the ambient light environment. In some implementations, a world-facing image sensor of head mounted device 400 that is oriented to receive scene light 456 may function as an ambient light sensor. Ambient light sensor 423 may be configured to generate an ambient light measurement 429, including using photodiodes that have a lens or baffle element to restrict capturing light over a finite FOV.

Ambient light sensor 423 may be comprised of a 2D sensor (e.g., a camera) capable of mapping a solid angle FOV onto a 2D pixel array. There may be many such 2D sensors (cameras), and these cameras can have optical elements, modules, data readout, analog-to-digital converters, etc. Ambient light sensor 423 may also be sensitive to color and brightness of a scene, thereby mapping the scene accurately across the spectral range. Ambient light sensor 423 may also be polarization-sensitive and thereby capable of detecting S versus P polarized light, and may be configured to capture and transmit data at frame rates in the same order of magnitude as the display frame rate.

In the illustrated implementation, processing logic 470 is configured to receive ambient light measurement 429 from ambient light sensor 423. Processing logic 470 may also be communicatively coupled to ambient light sensor 423 to initiate the ambient light measurement.

In some embodiments, transparency modulation layer 450 is made up of one or more materials that are sensitive to temperature, such that temperature changes (e.g., increases or decreases in temperature due to ambient temperature, incident energy such as sunlight, heat generated during operation, etc.) may affect the transparency performance (e.g., light transmission capability) of the dimming element. Hence, a temperature sensor 431 can be provided in/on or near transparency modulation layer 450 so as to detect the temperature of transparency modulation layer 450, and to provide a corresponding temperature measurement 432 to processing logic 470.

Furthermore in some embodiments, a display brightness sensor 433 may be provided within, behind, or in front of display layer 440 so as to sense/measure the brightness of display layer 440, and then provide a corresponding display brightness measurement 434 to processing logic 470. For example, the brightness of display layer 440 can typically be determined processing logic 470 by knowing the input power provided to display layer 440 and then comparing this input power with known brightness values (such as via a lookup table). The contents of the lookup table and other known values may be derived from factory settings or other known characteristics of display layer 440 at the time of manufacture.

However, the brightness characteristics/performance of display layer 440 may change over time and with age/use. Thus, display brightness sensor 433 provides a more accurate/true and real-time brightness value for display layer 440.

Display brightness sensor 433 may be positioned at any one or more locations that are suitable to determine the brightness of display layer 440. For example, display brightness sensor 433 may be located at an input and/or output of a waveguide (e.g., waveguide 158A in FIG. 1) of display layer 440.

In operation, transparency modulator layer 450 may be driven to various transparency values by processing logic 470 in response to one or more of eye data, ambient light measurements 429, temperature measurement 432, display brightness measurement 434 and/or other display brightness data, or other input(s) or combinations thereof. By way of example, a pupil diameter of an eye may indicate that scene light 456 is brighter than the user prefers or the ambient light sensor 423 may indicate that scene light 456 is too high, such that the user may have difficulty viewing a virtual image in a scene. Other measurements of an ocular region (e.g. dimension of eyelids, sclera, number of lines in corner region 263, etc.) of the user may indicate the user is squinting and that scene light 456 may be brighter than the user prefers. Inputs from the temperature sensor 431 and display layer 440 may also be received at processing logic 470. Thus, a transparency of transparency modulator layer 450 may be driven by processing logic 470 to a transparency that makes the user more comfortable with the intensity of scene light 459 that propagates through transparency modulator layer 450, and/or driven to a transparency that changes an intensity of scene light 456 so as to improve the visibility of virtual image(s) superimposed on a scene. The transparency of transparency modulator layer 450 may be modulated to various levels between 10% transparent and 90% transparent or other ranges, in response to the eye data, the ambient light measurement, display brightness, etc. for example.

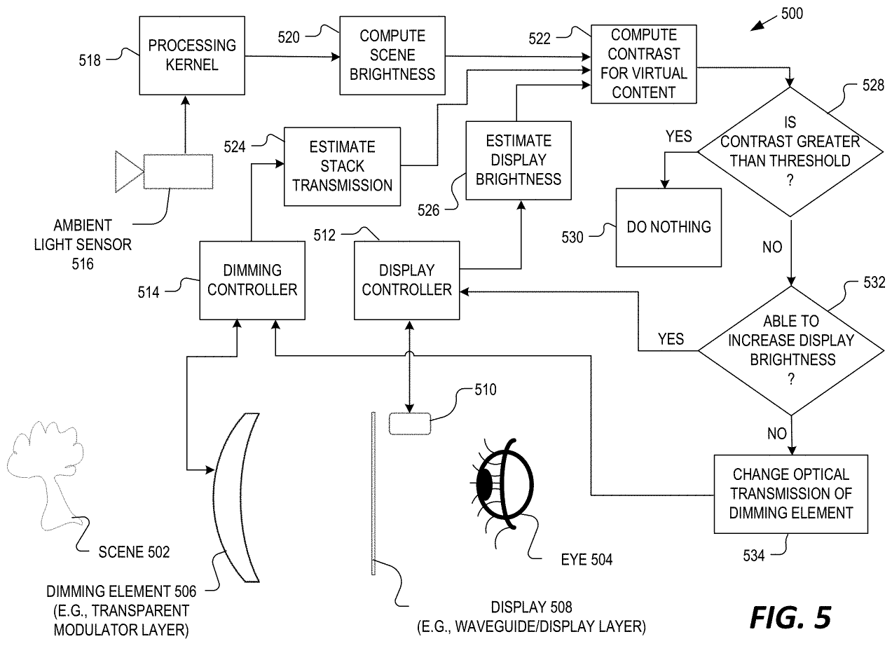

FIG. 5 is a flow diagram illustrating adaptive control of optical transmission, in accordance with aspects of the disclosure. More specifically, FIG. 5 is a flow diagram showing an example process 500 having operations and components that cooperate to control dimming, such as in an AR implementation using the head mounted device(s) previously described above, according to an embodiment.

The order in which some or all of the process blocks and related components appear in process 500 (and in any other process/method disclosed herein) should not be deemed limiting. Rather, one of ordinary skill in the art having the benefit of the present disclosure will understand that some of the process blocks may be executed in a variety of orders not illustrated, or even in parallel. Furthermore, some process blocks may be modified, combined, eliminated, or supplemented with additional process blocks.

For the process 500 of FIG. 5, a scene 502 is being viewed by an eye 504 of a user, using a head mounted device such as described previously above. As with the head mounted devices previously explained above, the head mounted device of FIG. 5 may include a transparent modulator layer having a dimming element 506 (which is operated/controlled by a dimming controller 514), and a display 508 in the form of a display layer with a waveguide and other display assembly components 510. The dimming element 506 is configured to modulate a transmission of the scene light to the eyebox area (e.g., the area of the eye 504) in response to a transmission command from the dimming controller 514.

Display 508 may be operated/controlled by a display controller 512. Display 508 is configured to present a virtual image (monocularly or binocularly) to an eyebox area (e.g., the area of the eye 504) of the head mounted device, and is configured to adjust a brightness level of the virtual image in response to commands from display controller 512.

An ambient light sensor 516 is configured to generate light data in response to measuring light at scene 502 in the external environment of the head mounted device. In operation, ambient light sensor 516 provides the light data or other signals to a processing kernel 518. Processing kernel 518 may be a signal processing kernel, for example, that is part of the processing logic (e.g., processing logic 470 in FIG. 4). In process block 520, the processing logic computes the scene brightness. For example, the processing logic may determine the scene brightness from light data obtained by processing the signals provided by ambient light sensor 516. This scene brightness becomes a first input into a process block 522.

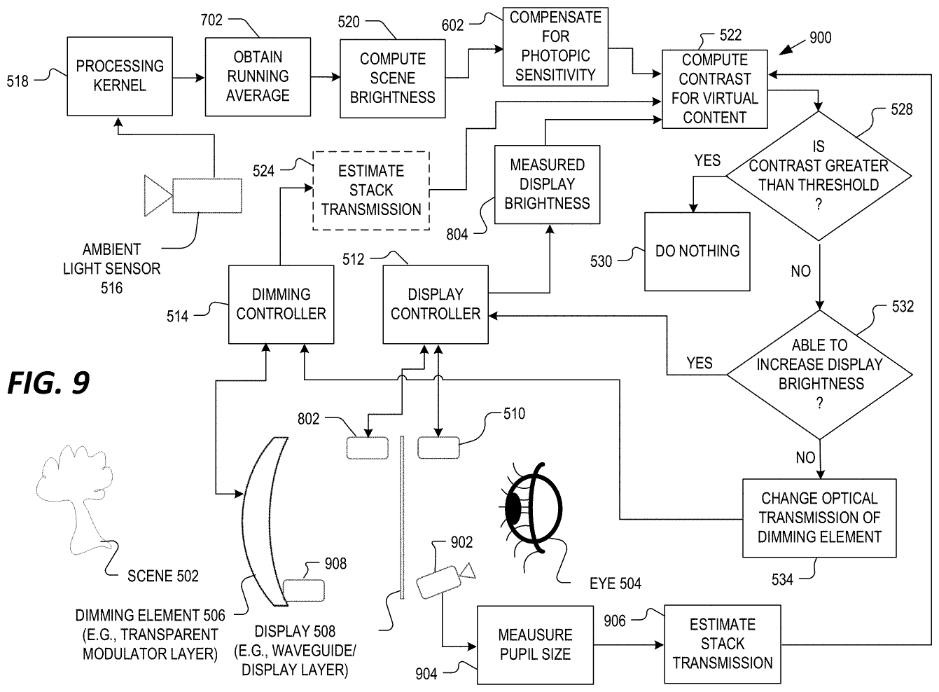

With respect to dimming element 506, dimming controller 514 controls (e.g., electrically, optically, etc.) the transmission characteristics (e.g., amount of dimming) of dimming element 506. Based on the control signals provided by dimming controller 514 to dimming element 506, the processing logic is able to estimate a stack transmission at a process block 524, as such via a lookup table that contains factory calibration information. This estimate of the stack transmission is provided as a second input to process block 522. Stack transmission may be estimated/measured in a more accurate manner, as compared to using factory calibration information, using a stack transmission sensor that will be described further below in FIG. 9.

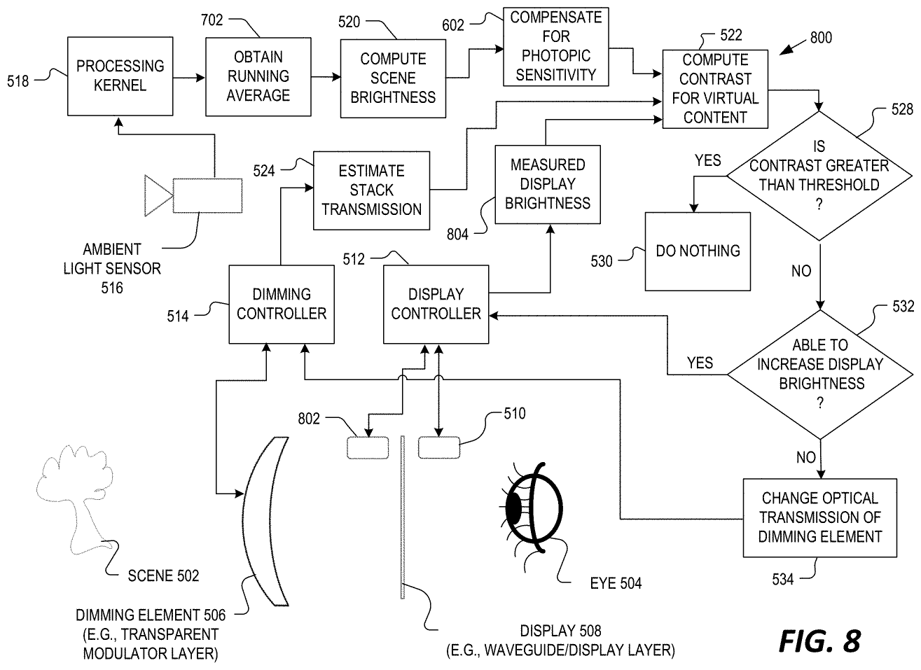

Analogously to the dimming controller 514, display controller 512 provides control signals and/or other signals to display 508. Based on the signal(s) provided by display controller 512 to display 508, the processing logic is able to estimate display brightness at a process block 526, as such via a lookup table that contains factory calibration information. This estimate of the display brightness is provided as a third input to process block 522. Display brightness may be estimated/measured in a more accurate manner, as compared to using factory calibration information, using a display brightness sensor that will be described further below in FIG. 8.

In process block 522, which may also form part of the processing logic, a contrast or contrast value for the virtual content (e.g., one or more virtual images) is computed based on at least some of the above-described first, second, and third inputs. The contrast value may represent an amount of visibility or clarity of the virtual content relative to the scene 502. Example formulas for computing the contrast value may be the following:

contrast=1+display/scene, wherein display and scene are the respective brightness values of display 508 and scene 502 in nits or lux, or

contrast=1+display/(transmittance*scene*reflectance), wherein transmittance is the stack transmission computed at process block 524 and reflectance represents the reflectivity of the transparent modulator layer.

The contrast value may be compared to a threshold, in which contrast values below the threshold would require adjustment (e.g., dimming) of the optical transmission of dimming element 506, and contrast values above the threshold (and up to a certain maximum value) would require little or no adjustment of the optical transmission of dimming element 506.

The contrast value may differ based on various use cases. For example, the contrast value may be different for a use case in which the scene is indoors versus outdoors; a use case for virtual reality (VR) versus augmented reality (AR), a use case in which a scene is inside a bright room versus a scene in a relatively darker room; etc. Various thresholds for contrast values may be stored in a lookup table and used at a process block 528.

In process block 528, the processing logic determines whether the computed contrast value is greater than the threshold. If the computed contrast value is greater than the threshold (“YES” at process block 528), then nothing is done at process block 530 (e.g., no change is made to the optical transmission of dimming element 506). The processing logic may then repeat process 500 described above for another set of first, second, third inputs.

If, however, the computed contrast is determined to be less than the threshold (“NO” at process block 528), then the processing logic checks at a block 532 as to whether the brightness of display 508 may be increased so as to increase the contrast. For instance, the processing logic checks whether the contrast of display 508 is below a maximum value, and if below (“YES” at process block 532), the processing logic instructs display controller 512 to increase the contrast by changing an amount or other value (e.g., amplitude and/or direction) of electrical actuation or by making other changes to the electrical input(s) to display 508.

If, however, the brightness of display 508 is unable to be increased any further (“NO” at process block 532), then the processing logic changes the optical transmission of dimming element 506 at a process block 534. For instance, the processing logic instructs dimming controller 514 to increase the dimming of dimming element 506, by changing by an amount of electrical/optical actuation or by making other changes to the electrical/optical input(s) to dimming element 506 (e.g., changing the value of an actuation signal, such amplitude and/or direction values). The change in transmission can vary between 0% to 100%, and may be applied to the entire visible spectrum. Furthermore, the change in transmission can happen at different transition times, and the rate of the transition can be manipulated as appropriate in various embodiments.

The process 500 then repeats as described above for another set of first, second, and third inputs.

As previously explained above with respect to FIGS. 3A and 3B, there may be areas in scene 502 that are relatively brighter than other areas in scene 502. Virtual images may then be superimposed over such areas, thereby making it more difficult to view the virtual images and details thereof. The embodiment of process 500 described above may use a monochrome camera as ambient light sensor 516. However, a monochrome camera may indicate certain areas as being bright due to higher infrared (IR) lighting being present at these areas, even though such IR is not actually visible to eye 504 of the user.

Therefore, to improve the detection of bright areas that are actually visible to the user, another embodiment uses a RGB camera as ambient light sensor 516 and uses an image processing kernel as processing kernel 518. As such, the effect of IR lighting is more effectively filtered out from scene 502, and the detection of visible bright areas (on which a virtual image is superimposed) can be improved by treating the outline of the virtual image as a region of interest (ROI) at the bright area(s) of scene 502.

In such an embodiment, the computation of brightness at process block 520 may involve considering the average brightness of scene 502, the peak brightness of scene 502, the average brightness over the ROI, the peak brightness over the ROI, the variance in brightness over the ROI, and/or other factors.

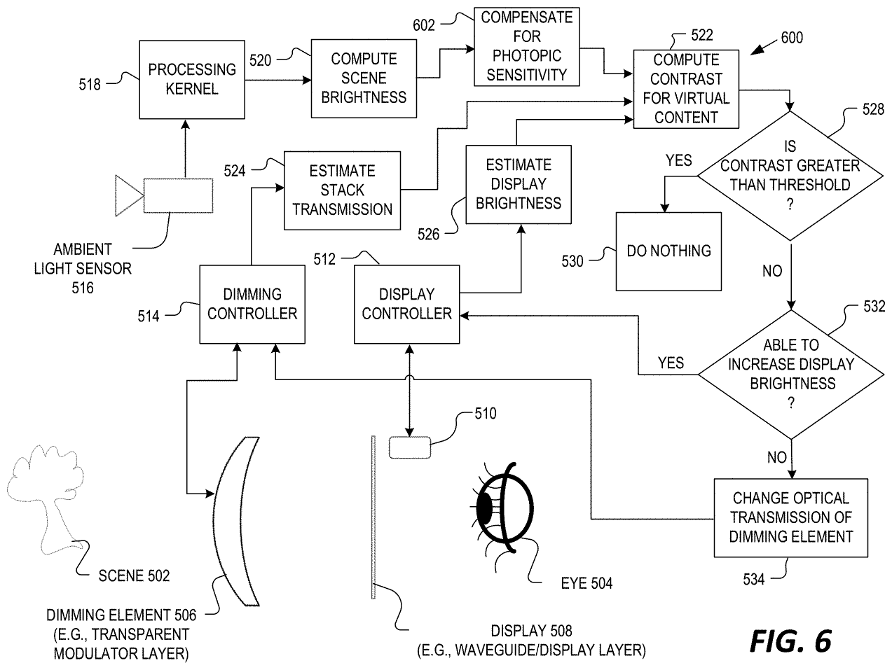

FIG. 6 is a flow diagram illustrating adaptive control of optical transmission according to another embodiment. More specifically, FIG. 6 shows an example process 600 having a further process block 602, with other process blocks and components in FIG. 6 being the same or similar as previously described above with respect to process 500 of FIG. 5 (and so the description of such same/similar process blocks and components are not repeated herein, for the sake of brevity).

In process block 602, compensation of photopic sensitivity of the user is performed on the brightness of scene 502 that was computed at process block 520, and the result is provided as the first input to process block 522 for the contrast computation. For example, some users (e.g., as they age) may have visual sensitivities to certain colors under different lighting conditions.

Thus at process block 602, compensation may be performed by multiplying/scaling the computed brightness by a photopic sensitivity curve. For instance, the brightness may be computed at process block 520 based at least on the average brightness of scene 502, the peak brightness of scene 502, the peak brightness over the ROI, and the variance in brightness over the ROI, and then multiplied at process block 602 by one or more values in a photopic sensitivity curve that corresponds to the user.

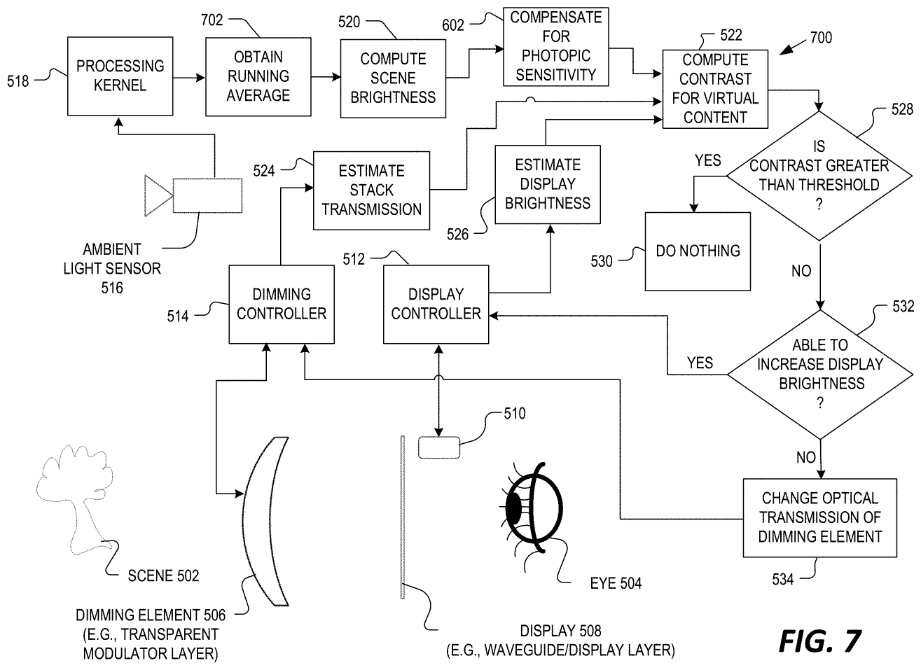

FIG. 7 is a flow diagram illustrating adaptive control of optical transmission according to still another embodiment. More specifically, FIG. 7 shows an example process 700 having a further process block 702, with other process blocks and components in FIG. 7 being the same or similar as previously described above with respect to process 600 of FIG. 6 (and so the description of such same/similar process blocks and components are not repeated herein, for the sake of brevity).

In process block 702, the processing logic obtains/computes a running average of scene 502 over the last several N frames of images taken by the RGB camera, wherein N may be an integer greater than 1. One purpose of taking the running average to provide increased robustness against flickering light in scene 502.

For example, there may be a latency between when scene brightness is computed (for a single frame) and when the transmittance of dimming element 506 is adjusted based on that computed brightness. Due to the latency and if flickering light is present, the adjustment of the dimming element 506 might end up being performed when the original brightness (based on which the transmittance was computed) is no longer present or has changed. Thus, the transmittance adjustments may be ineffective in that the adjustments are not synchronized with rapid/flickering brightness changes, thereby not achieving the desired visual enhancements for the virtual image and potentially resulting in annoyance to the user.

By using the running average of N frames of scene 502 at process block 702, adjustments in the transmittance may be performed at process block 534 that are more stable and less annoying to the user.

FIG. 8 is a flow diagram illustrating adaptive control of optical transmission according to yet another embodiment. More specifically, FIG. 8 shows an example process 800 having a further component 802 and a process block 804 replacing process block 526, with other process blocks and components in FIG. 8 being the same or similar as previously described above with respect to process 700 of FIG. 7 (and so the description of such same/similar process blocks and components are not repeated herein, for the sake of brevity).

Component 802 may be a display brightness sensor (e.g., display brightness sensor 433 shown in FIG. 4) including some type of disparity sensor. As previously noted above, brightness of display 508 might be estimated during calibration at the manufacturing stage. The net brightness perceived at the eyebox may be a function of coatings, ultra LEDs (ULEDs), waveguides, holographic optical elements, etc. of displays, which have characteristics that may change due to aging, yellowing, instability, or other reasons. As such, the net brightness during factory calibration may not accurately provide the true brightness of display 508. A drift in the factory calibration could thus result in inaccuracies in the estimation of display brightness at previous process block 526.

Hence, the use of component 802 (display brightness sensor) serves to reduce the uncertainty in the determination of the brightness of display 508, regardless of the source of the uncertainty. In operation, component 802 measures actual brightness of display 508 and provides this information as an output in analog or digital format, and the processing logic in turn provides (at process block 804) the measured brightness as the third input to process block 522 for computation of the contrast.

The display brightness sensor may be located near the in-coupling grating so as to capture light that does not couple into the grating, near the boundary at the edge of the waveguide, or at other location(s). A disparity sensor may also be used as the display brightness sensor since the disparity sensor can capture some of the light coming from display 508.

A display brightness sensor can also be added to assemblies such as mounts, lenses, etc. of the head mounted device, as tiny photodiode sensor(s) facing display 508 instead of the scene 502 (e.g. like VCSELs but not facing the eye). One or more photodiodes can be used.

The display brightness sensor can track the absolute brightness of display 508 through a prior calibration or track the relative change in brightness of display 508 in real time. Also, the display brightness sensor can generate brightness measurement data at frame rates, and can measure the average display brightness or peak brightness or both, and can measure across all wavelengths and field of view.

FIG. 9 is a flow diagram illustrating adaptive control of optical transmission according to yet another embodiment. More specifically, FIG. 9 shows an example process 900 having an eye tracking camera 902 (e.g., camera 477 in FIG. 4), a further process block 904, and a process block 906 that may replace or supplement process block 524 (for measuring stack transmission) which is now depicted in broken lines, with other process blocks and components in FIG. 9 being the same or similar as previously described above with respect to process 800 of FIG. 8 (and so the description of such same/similar process blocks and components are not repeated herein, for the sake of brevity.

As previously explained above, the pupil size of eye 504 may vary from one user to another, and may also vary according to different lighting or other different conditions. For instance, pupil size may change due to the user's age and/or due to brightness.

However, the brightness measured by ambient light sensor 516 might not be the same as the brightness perceived by eye 504 through the optical stack. The estimate of transmission of the optical stack at any given time (at the process block 524) may be based on factory calibration of optical elements, including dimming element 506. More accurate estimation may be provided by using camera 902 to measure pupil size at process block 904.

The measured pupil size may then be used by the processing logic at process block 906 to provide a more accurate estimate of the stack transmission. As such, the camera 902 may operate as or in conjunction with a stack transmission sensor 908 for generating a transmission light measurement/estimate (as well as performing other operations such as tracking gaze of scene 502 by the user). This estimate of the stack transmission is then provided as an input to process block 522 for computation of the contrast.

The camera 902 may also provide other types of eye-tracking data to the processing logic to enable the processing logic to determine head pose and eye pose of the user, thereby enabling capability to make a prediction about where the virtual image will be overlaid on top of scene 502 in the next several frames or cycles. The processing logic has contextual awareness of the virtual content being delivered and can determine the relationship of this virtual content with respect to areas in scene 502, and can therefore make contrast adjustments based on where the virtual content is located or will be located.

With respect to stack transmission sensor 908 that generates a transmission light measurement, the transmission light measurement can be provided at process block 524 (via dimming controller 514) and/or at process block 906. As such, this transmission light measurement may represent a real time measurement that is more accurate than transmission light measurement that was obtained during factory calibration. Stack transmission sensor 908 may be located at or near the surface of dimming element 506, and multiple stack transmission sensors can be located on both surfaces of dimming element 506 (e.g., inside and outside).

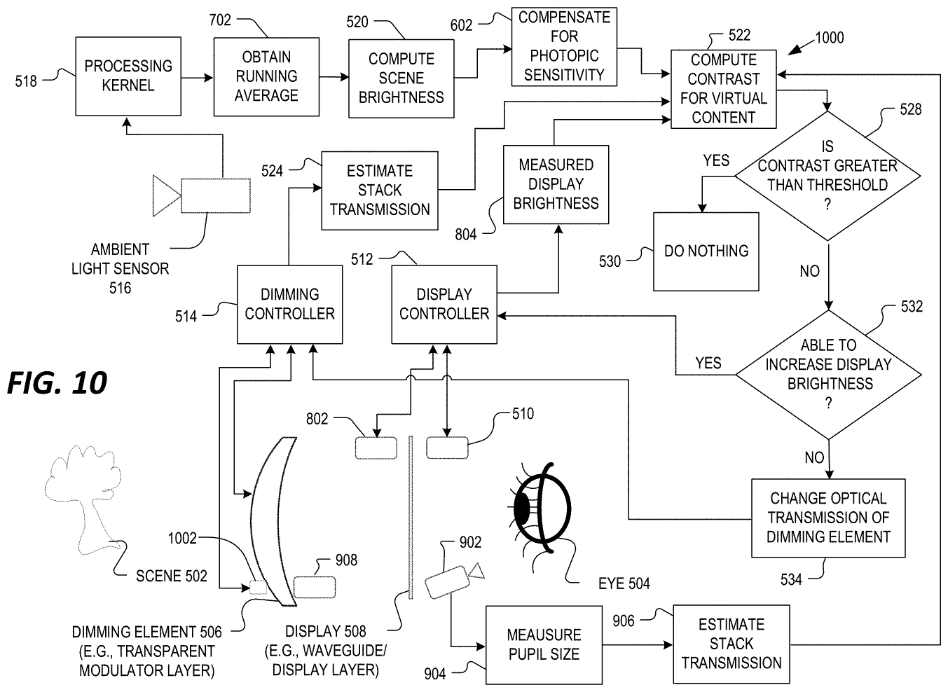

FIG. 10 is a flow diagram illustrating adaptive control of optical transmission according to yet another embodiment. More specifically, FIG. 10 shows an example process 1000 having a temperature sensor 1002 (e.g., temperature sensor 431 in FIG. 4), with other process blocks and components in FIG. 10 being the same or similar as previously described above with respect to process 900 of FIG. 9 (and so the description of such same/similar process blocks and components are not repeated herein, for the sake of brevity.

Temperature sensor 1002 may be coupled to dimming element 506 so as to measure the temperature of dimming element 506, since the transmission characteristics of dimming element 506 may change in response to changes in temperature. The measured temperatures may be provided to dimming controller 514, and used by the processing logic to estimate the stack transmission at process block 524 (now shown in solid lines in FIG. 10).

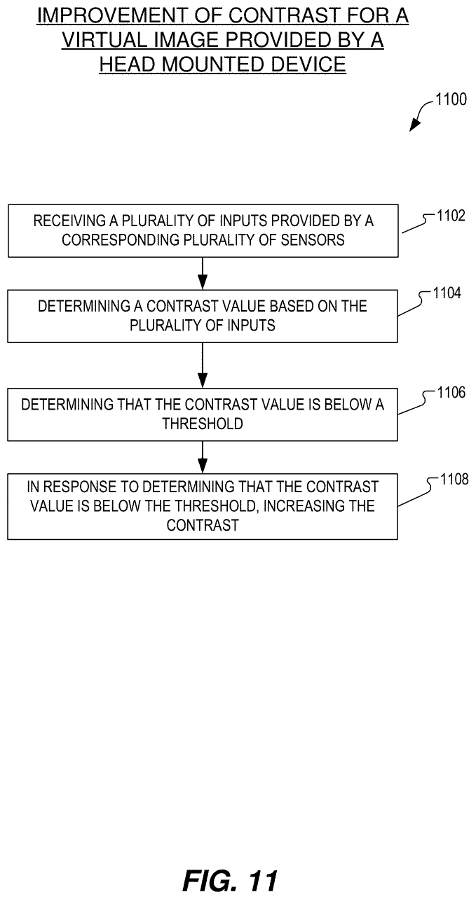

FIG. 11 illustrates a flow chart of an example method 1100 to improve contrast for a virtual image provided by a head mounted device, in accordance with aspects of the disclosure. The operations in method 1100 may be performed by processing logic and may be based on the techniques, devices, components, etc. as previously described above, in which a virtual image is overlayed over a scene in a FOV of a head mounted device.

In a process block 1102, the processing logic receives a plurality of inputs provided by a corresponding plurality of sensors. The plurality of sensors may include the ambient light sensor 516, temperature sensor 1002, display brightness sensor 802, stack transmission sensor 908, camera 902, etc., such that the plurality of inputs are associated with a brightness of the scene light and the brightness level of display 508.

In a process block 1104, the processing logic determines a contrast value based on the plurality of inputs. The contrast value corresponds to a contrast of the virtual image that is overlayed on scene 502. The contrast value may indicate whether the virtual image is satisfactorily visible to the user of the head mounted device. For instance, if the scene is too bright, or the virtual image is superimposed over a bright area of the scene, the details of the virtual image may be difficult for the user to see.

In a process block 1106, the processing logic determines that the contrast value is below a threshold, thereby indicating that the user may have difficulty viewing details of the virtual image due to excessive brightness in scene 502. As explained previously above, the threshold value for contrast may vary from one use case to another.

In a process block 1108, the processing logic increases the contrast, in response to determining that the contrast value is below the threshold, by changing at least one of an optical transmission of dimming element 506 through which the scene light passes, or the brightness level of display 508. Factors such as the ROI of the virtual image over scene 502, the transmission characteristics (e.g., properties) of dimming element 506, changing brightness characteristics of display 608, temperature of dimming element 506, the pupil size of eye 504, and/or other factors can influence the determination of whether to change the contrast, and if so, the technique by which the contrast may be changed.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., processing logic 470) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g. memory 475) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels or any communication links/connections may include or be routed through one or more wired or wireless communication utilizing IEEE 802.11 protocols, BlueTooth, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head mounted device, comprising:
a light sensor configured to generate light data in response to measuring scene light in an external environment of the head mounted device;
a display configured to present a virtual image to an eyebox area of the head mounted device, wherein the display is configured to adjust a brightness level of the virtual image;
a near-eye dimming element configured to modulate a transmission of the scene light to the eyebox area in response to a transmission command; and
processing logic configured to adjust the transmission command of the near-eye dimming element in response to the brightness level of the virtual image and the light data generated by the light sensor.

2. The head mounted device of claim 1, wherein the processing logic is further configured to:
generate an image contrast value in response to the transmission command of the near-eye dimming element, the brightness level of the virtual image, and the light data generated by the light sensor; and
increase the brightness level of the display in response to the image contrast value falling below a contrast threshold value.

3. The head mounted device of claim 1, wherein the processing logic is further configured to:
generate an image contrast value in response to the transmission command of the near-eye dimming element, the brightness level of the virtual image, and the light data generated by the light sensor, and wherein the processing logic is also configured to adjust the transmission command in response to the image contrast value falling below a contrast threshold value, wherein the adjusting the transmission command by the processing logic includes adjusting the transmission command to reduce the transmission of the scene light through the near-eye dimming element.

4. The head mounted device of claim 1, wherein the light sensor includes an image sensor and the light data includes a scene image of the external environment, and wherein the processing logic is further configured to:
identify a region of interest (ROI) in the scene image, wherein the ROI in the scene image is where the virtual image overlays the external environment in the scene image;
determine an ROI brightness value within the ROI of the scene image; and
adjust the brightness level of the virtual image in response the ROI brightness value or adjust the transmission command of the near-eye dimming element in response to the ROI brightness value.

5. The head mounted device of claim 1, wherein the light sensor includes an image sensor and the light data includes a scene image of the external environment, and wherein the processing logic is further configured to:
identify a region of interest (ROI) in the scene image, wherein the ROI in the scene image is where the virtual image overlays the external environment in the scene image; and
determine an ROI brightness value within the ROI of the scene image, wherein the processing logic is also configured to adjust the transmission command of the dimming element in response to the ROI brightness value, wherein the adjusting the transmission command by the processing logic includes instructing a dimming controller, coupled to the dimming element, to change a value of an actuation signal that controls the dimming element.

6. The head mounted device of claim 1, further comprising:
a display brightness sensor configured to measure a display brightness value of the display, wherein the processing logic is also configured to adjust the transmission command of the dimming element in response to the measured display brightness value.

7. The head mounted device of claim 1, further comprising:
a stack transmission sensor configured to generate a transmission light measurement of the scene light that transmits through a near-eye element that includes the near-eye dimming element, wherein the processing logic is also configured to adjust the transmission command of the dimming element in response to the transmission light measurement.

8. The head mounted device of claim 1, further comprising:
a temperature sensor configured to measure a dimming element temperature of the near-eye dimming element, wherein the processing logic is also configured to adjust the transmission command of the dimming element in response to the dimming element temperature.

9. The head mounted device of claim 1, wherein the processing logic is configured to:
compute a moving average of the light data generated by the light sensor, wherein the moving average corresponds to flickering of the scene light in the external environment; and
compensate for photopic sensitivity by applying a photopic sensitivity curve to the moving average of the light data.

10. A method to improve contrast for a virtual image provided by a head mounted device, the method comprising:
receiving a plurality of inputs provided by a corresponding plurality of sensors, wherein the plurality of inputs is associated with a brightness of scene light in an external environment of the head mounted device and a brightness level of a display of the head mounted device;
determining a contrast value based on the plurality of inputs, wherein the contrast value corresponds to a contrast of the virtual image being overlayed on a scene associated with the external environment;
determining that the contrast value is below a threshold; and
in response to determining that the contrast value is below the threshold, increasing the contrast by changing at least one of an optical transmission of a near-eye dimming element of the head mounted device through which the scene light passes, or the brightness level of the display.

11. The method of claim 10, wherein the plurality of inputs include:
a first input that represents the brightness of the scene light in the external environment;
a second input that represents a transmission characteristic of the dimming element;
a third input that represents the brightness level of the display; and
a fourth input associated with a pupil size of a user of the head mounted device, wherein the pupil size is also representative of the transmission characteristic of the dimming element.

12. The method of claim 10, further comprising:
determining a region of interest (ROI) of the virtual image, wherein the ROI is overlayed on a first area of the scene that has a higher intensity of the scene light relative to other areas of the scene,
wherein a first input of the plurality of inputs represents the intensity of the scene light at the first area, and
wherein increasing the contrast includes increasing the contrast based on the intensity of the scene light at the first area.

13. The method of claim 12, wherein determining the contrast value includes computing the contrast value based at least on an average of the scene light over the scene, a peak of the scene light over the scene, an average of the scene light over the ROI, a peak of the scene light over the ROI, and a variance of the scene light over the ROI.

14. The method of claim 10, further comprising:
computing a moving average of frames of the scene, wherein the moving average corresponds to flickering of the scene light in the external environment; and
compensating for photopic sensitivity by applying a photopic sensitivity curve to the moving average,
wherein a first input of the plurality of inputs represents a brightness value of the scene and which corresponds to the moving average having the photopic sensitivity curve applied thereto.

15. The method of claim 10, further comprising:
determining a temperature associated with the dimming element; and
using the determined temperature to determine the optical transmission characteristic of the dimming element, wherein at least one of the plurality of inputs is associated with the transmission characteristic determined from the temperature.

16. The method of claim 10, wherein at least one of the plurality of inputs is associated with a brightness level of the display, and wherein the brightness level of the display is determined from factory calibration data and from a display brightness sensor that provides a real-time value of the brightness of the display.

17. The method of claim 10, wherein an input of the plurality of inputs is associated with images of the scene captured by a RGB camera, and wherein the RGB camera filters nonvisible light from the images.

18. A head mounted device, comprising:
a light sensor configured to generate light data in response to measuring scene light in an external environment of the head mounted device;
a display configured to present a virtual image to an eyebox area of the head mounted device; and
a near-eye dimming element configured to modulate a transmission of the scene light to the eyebox area;
a display brightness sensor configured to generate a measured display brightness value of the display; and
processing logic configured to change a contrast of the virtual image in response to the measured display brightness value and the light data generated by the light sensor.

19. The head mounted device of claim 18, further comprising:
an eye-tracking camera configured to generate an eye-tracking image of the eyebox area, wherein the processing logic is configured to change the contrast by adjusting a transmission command to the dimming element in response to the measured display brightness value, the light data generated by the light sensor and the eye-tracking image.

20. The head mounted device of claim 18, wherein the processing logic is configured to change the contrast of the virtual image in response a brightness value computed based on the light data, wherein the brightness value is computed by the processing logic from a moving average of the scene light, wherein the moving average corresponds to flickering of the scene light in the external environment, and wherein the processing logic compensates for photopic sensitivity by applying a photopic sensitivity curve to the moving average to obtain the brightness value.
